(19) United States
(12) Patent Application Publication
(10) Pub. No.: US 2020/0130947 A1
(43) Pub. Date: Apr. 30, 2020

(54) AUTOMATED CONVEYING DEVICE

(71) Applicant: Nils DICKFELD, Alsbach-Hähnlein (DE)

(72) Inventor: Nils DICKFELD, Alsbach-Hähnlein (DE)

(21) Appl. No.: 16/493,421

(22) PCT Filed: Mar. 8, 2018
(86) PCT No.: PCT/EP2018/055809

§ 371 Date: Oct. 18, 2019

(30) Foreign Application Priority Data
Mar. 17, 2017 (DE) 10 2017 105 791.9

(51) Int. Cl. B65G 43/10; B65B 1/04; B65B 35/22; B65B 57/20; B65B 5/10

(52) U.S. Cl. CPC B65G 43/10; B65B 1/04; B65G 2203/044; B65B 57/20; B65B 5/103; B65B 35/22

(57) ABSTRACT

An automated conveying device for tablet-shaped products, for example confectionery products, pharmaceutical tablets or capsules, includes a line-forming conveyor belt, on which the tablet-shaped products are stored in separate lines transversely to a conveying direction of the conveyor belt and are transported in the conveying direction, as well as a feeding device, which is arranged at a first end of the conveyor belt for feeding the tablet-shaped products on the conveyor belt, and a filling device, which is arranged at a second end opposite the first end of the conveyor belt, by which the tablet-shaped products can be transferred from the conveyor belt into a filling container. The automated conveying device also includes an optical detection device for the automated detection of individual tablet-shaped products on the conveyor belt. The feeding device has a track-forming separation device, b which the tablet-shaped products are fed in a plurality of tracks next, to one another onto the upper side of the conveyor belt. The conveyor belt can include at least in the region of the feed opening of the feeding device an alignment rising upwardly in the conveying direction.

### BACKGROUND AND SUMMARY

The invention relates to an automated conveying device for tablet-like products, for example confectionary, pharmaceutical tablets or capsules.

Various automated conveying devices are known in practice, by means of which tablet-like products can be conveyed from a storage container to a filling system or to a further container. In the case of conveying devices having a structurally simple configuration, the conveying device essentially comprises a continuously revolving conveyor belt on which the individual tablet-like products can be arranged and conveyed to the filling device provided therefore or to the further container. In this case, a manual check of the individual tablet-like products, and an also usually manual separation of faulty tablet-like products can take place during conveyance of the tablet-like products. In this case, the check, which is usually performed by a checker, can take account of various criteria such as the shaping or the coloring of the tablet-like products and, by manual elimination of products that do not meet these criteria, can ensure that only tablet-like products that meet the specified criteria are supplied to the filling device or the further container. A manual check and separation by a checker is very laborious and significantly restricts the maximum possible conveying capacity of the conveying device.

Conveyor belts are known that comprise a roller belt having rotatably mounted rollers that are oriented transversely to the conveying direction and are arranged so as to be spaced apart in the conveying direction. In this case, a portion between two adjacent rollers is smaller than a smallest diameter of the tablet-like products to be conveyed, with the result that the tablet-like products are arranged substantially automatically in mutually separated rows extending transversely to the conveying direction and are transported in the conveying direction in the mutually separated rows that are specified by the orientation of the spaced apart roller. Arranging the tablet-like products in mutually separated rows can facilitate a manual check and the separation of faulty products.

Furthermore, feeding devices are known in practice in which the tablet -like products supplied to the conveying device are supplied to the conveyor belt via a vibrating sheet having a slight inclination. Upwardly protruding side walls of the vibrating sheet surround an interior of a feeding container that comprises a feeding opening facing the conveyor belt, in the conveying direction, through which opening the individual tablet-like products arrive on the conveyor belt. In order to prevent the tablet-like products from arriving on the conveyor belt on top of one another, in a plurality of layers, and thus impeding a visual inspection and check by a checker, it is generally necessary to specify a sufficiently low conveying speed or conveying capacity and for the vibratory movement of the feeding device to be adjusted thereto, in order that not too many tablet-like products are fed simultaneously into the individual rows of the conveyor belt.

Furthermore, conveying devices are known in practice that fill provided containers, in an automatic or semi-automatic manner, with specifiable quantities counted into portions, by means of vibrators, turntables or conveyor belts in conjunction with product counters and actuatable flaps or switches. The conveying devices known in practice are structurally complex and prone to faults during operation.

It is desirable to provide an automated conveying device such that as high as possible a conveying capacity of the automated conveying device is made possible by the simplest possible configuration measures, and in addition automated capture of the tablet-like products conveyed on the conveyor belt is made possible.

According to an aspect of the invention, an automated conveying device is provided that comprises a row-forming conveyor belt on which the tablet-like products are stored in mutually separated rows, transversely to a conveying direction of the conveyor belt and are transported in the conveying direction, wherein the automated conveying device comprises a feeding device, arranged at a first end of the conveyor belt, for feeding the tablet-like products onto the conveyor belt, an optical capture means fur automated capture of individual tablet-like products on the conveyor belt, and a filling device arranged at a second end of the conveyor belt that is opposite the first end, by leans of which the tablet-like products can be transferred from the conveyor belt into a filling container. Any desired tablet-like products can be conveyed using the automated conveying device according to the invention automated, and therefore the use of the conveying device is not restricted to tablets and capsules from the field of pharmaceutics. The conveying device according to the invention is furthermore also suitable for conveying spherical and cylindrical products, as well as for conveying nut-shaped and egg-shaped products. The conveying device according to the invention will be explained in greater detail in the following in the context of conveying tablet-like products, but without this being intended to imply a restriction to, for example, tablets.

Using a row-forming conveyor belt means that the tablet-like products fed onto the conveyor belt by the feeding device are stored on the conveyor belt in mutually separated rows that are oriented transversely to the conveying device. The tablet-like products are supplied to the optical capture means in this m separated row-like arrangement, which device performs automated capture of the individual tablet-like products on the conveyor belt. The capture can be performed using suitable optical recording means, such as analogue or digital cameras or photographic recording means. In this case, the optical capture means can be used to count the tablet-like products conveyed on the conveyor belt, in order to facilitate and optionally control, in an automated manner, the subsequent filling by means of the filling device arranged at the second end of the conveyor belt. It is also possible for the optical capture means to be operated as an optical inspection means and to, be used to check the individual tablet-like products and to monitor whether specified quality criteria, such as a specified shaping, or coloring, are met. If an individual tablet-like product does not meet the specified criteria, an optical or acoustic notification can be given, and a checker can thus be made aware of the relevant faulty tablet-like product. In this way, the automated conveying device can be operated at a high conveying capacity, and at the same time reliable quality control and filling of the tablet-like products can take place. The filling device can be configured such that, in the case of continuous operation of the conveyor belt, a plurality of filling containers can be filled in direct succession or simultaneously.

According to an embodiment according to the invention, the feeding device may comprise a feeding opening that adjoins an upper face of the conveyor belt and extends transversely to the conveying direction of the conveyor belt and through which the tablet-like products can be fed onto the upper face of the conveyor belt. The use of a row-forming conveyor belt means that it is not essential to supply the tablet-like products to the conveyor belt already pre-sorted in a row-like manner, for example by means of a vibrating sheet or the like. Instead, the feeding; device may comprise an extensive and for example rectangular feeding opening on a lower face, which opening extends transversely to the conveying device of the conveyor belt and allows for feeding of the tablet-like products over a conveying width of the conveying unit that also extends transversely to the conveying direction. The feeding opening can be delimited on three sides by side walls that reach directly to an upper face of the conveyor belt and prevent individual tablet-like products from emerging laterally from the feeding device, along the side walls, and being able to arrive on the conveyor belt or in laterally adjacent regions in an uncontrolled manner. The side walls arranged along a peripheral edge of the feeding opening are configured, in particular with respect to the spacing thereof from the upper face of the conveyor belt, such that it is only possible for a single layer of the tablet-like products to arrive on the conveyor belt, through the feeding opening, and to be conveyed further in the conveying direction, along one of the side edges of the feeding opening facing the conveying direction of the conveyor belt. As a result, the entire surface of the feeding opening can be used to ensure that the individual tablet-like products are arranged on the upper face of the conveyor belt and are oriented such that a plurality of tablet-like products are arranged side-by-side in one row of the conveyor belt and are conveyed away from the feeding device, in the conveying direction.

It is optionally possible, according to the invention, fill the feeding device to comprise a track-forming separation device by means of which the tablet-like products are fed side-by-side, in a plurality of tracks, onto the upper face of the conveyor belt. The conveying width of the conveyor belt is expediently sufficiently large that a plurality of tablet-like products can be arranged side-by-side in a single line of the row-forming conveyor belt, in this case, it is preferably possible for more than five or more than ten tablet-like products to be able to be arranged side-by-side in each of the rows. A track-forming separation device promotes an arrangement of the individual tablet-like products side-by-side, in a plurality of tracks, on the upper face of the conveyor belt. This makes it possible for a number of tablet-like products specified by the separation device to be arranged side-by-side in each row of the row-forming conveyor belt. The tablet-like products arranged side-by-side form a corresponding number of tracks, in the conveying direction, which tracks are arranged side-by-side on the upper face of the conveyor belt and are oriented in the conveying direction.

A suitable configuration of the track-I⁻brining separation device makes it possible to ensure that a corresponding number of tablet-like products are arranged side-by-side in each row, and that the individual tracks of the tablet-like products are oriented in the conveying direction and are formed having a specified position of the individual tablet-like products in the relevant rows of the conveyor belt.

According to an advantageous embodiment of the inventive concept, the track-forming separation device comprises a plurality of separation elements arranged transversely to the conveying direction of the conveyor belt. The separation elements may for example'be partition elements or tongues that are oriented in the conveying direction and that protrude as far as an upper face of the conveyor belt and force the tablet-like products, conveyed out of the feeding device through the feeding opening, in the conveying direction, between the individual separation elements, in order to thus specify the position of said products side-by-side in each individual row of the row-forming conveyor belt. It is also possible for circular discs to be provided instead of or in addition to partition elements or tongues of this kind, which discs are rotatably mounted on a shaft oriented transversely to the conveying direction and which likewise protruded directly up to the upper face of the conveyor belt and forcibly position the tablet-like products between adjacent circular discs. In this case, the circular discs:may rotate in the same direction as or in the opposite direction from the conveying direction of the conveyor unit. The spacing, between the individual partition elements or tongues, and/or the mutual spacing of adjacent circular discs, is expediently slightly greater than the largest longitudinal extension of the tablet-like products.

The track-forming separation device is expediently arranged in the region of the feeding opening, and in particular on a side edge of the feeding opening that faces in the conveying direction. It may be expedient for further, separation devices to be arranged along the conveyor path of the conveyor belt, so as to be spaced apart from the feeding device, such that the tablet-like products already arranged in a track-like manner on the conveyor belt can be checked with respect to the positions thereof, and optionally repositioned, in order for it to be possible to ensure the track-like arrangement of the tablet-like products over the entire conveying lengths of the conveyor belt.

In order to prevent a plurality of tablet-like products, arranged on top of one another, from being fed onto the conveyor belt simultaneously through the feeding opening, in the interior of the feeding device, according to an embodiment of the inventive concept the feeding device consequently comprises a layer separation means in the region of the feeding opening. As a result of the layer separation means, just one single layer of tablet-like products is fed onto the upper face of the conveyor belt, through the feeding opening. The layer separation means can for example be formed by a slotted recess in the side wall of the feeding device that faces in the conveying direction, wherein the dimensions of the slotted recess are adjusted to the dimensions of the tablet-like products such that in each case just one individual layer can leave the feeding device through the slotted recess and, in the interior, tablet-like products still arranged on top of one another can be removed from the wall region of the side wall adjacent to the slotted recess and retained in the interior of the feeding device. The slotted recess can be delimited, in an edge region of the recess opposite the upper face of the conveyor belt, by a height-adjustable screen, such that the dimensions of the slotted recess can be adjusted to tablet-like products of different sizes.

It is also possible and, in view of high conveying capacities, advantageous, for rotating brushes or cloth rollers to be arranged on the lateral edge of the feeding opening, in the feeding device, close to the slotted recess facing the conveying direction, which brushes or rollers remove front a lowest layer of tablet-like products arranged on the upper face of the conveyor belt, and retain in the interior of the feeding device, tablet-like products that are arranged on top of one another and are stacked above said products. In this case, the brushes or cloth rollers can rotate about an axis of rotation that is transverse to the conveying direction or is arranged so as to be at an oblique angle relative to the conveying direction of the conveyor belt.

The removal of further product layers located on top of one another, on a lowest layer of tablet-like products, can be promoted in that the row -forming conveyor belt comprises a three-dimensionally structured depression for receiving a plurality of tablet-like products, arranged side-by-side, in a row-like manner, such that an upper face of the tablet-like products arranged in the relevant row of the conveyor belt protrudes as little as possible above an upper face of the conveyor belt.

According to an optional embodiment of the inventive concept, feeding of the tablet-like products onto the row-forming conveyor belt that is as reliable and uniform as possible can be assisted and promoted by means of the conveyor belt having an orientation that rises upwards in the conveying direction, at least in the region of the feeding opening of the feeding device. The upwardly rising orientation of the conveyor belt in the region of the feeding opening of the feeding device promotes the removal and retention of tablet-like products initially still arranged above one another, inside the interior of the feeding device.

According to an advantageous embodiment of the inventive concept, the optical capture means comprises at least one optical recording means that is arranged transversely to the conveying direction of the conveyor belt and extends over a conveying width of the conveyor belt. An optical recording means of this kind makes it possible for the entire conveying width of the conveyor belt to be captured in just one recording, and for an optical check of the tablet-like products arranged thereon to be performed. In this way, it is possible for an individual row of tablet-like products arranged side-by-side on the conveyor belt to be optically captured and checked substantially simultaneously. The optical capture means makes it possible for reliable capture and counting of the tablet-like products, conveyed by the conveyor belt, to be performed even at high conveying speeds of the conveyor belt that is moved in the conveying direction. It may also be expedient for a plurality of optical recording means to be arranged so as to be mutually spaced in the conveying direction of the conveyor belt. The plurality of recording means can make a plurality of successive recordings of the same tablet-like products, during a conveying, movement of the tablet-like products along the conveyor belt. Recordings from different viewing angles relative to the conveying direction, are also possible, allowing for more accurate capture and evaluation of the optically captured tablet-like products,

According to an optional embodiment of the inventive concept, the optical capture means comprises a further optical recording means or a mirror device arranged laterally beside the conveyor belt, which allows for optical capture of the tablet-like products, conveyed on the conveyor belt, from a lateral viewing angle. In this way, the individual tablet-like products can for example not only be optically captured from above the conveyor belt, but can also be captured and checked by means of optical recordings directed laterally. This is possible for example by means of one or more recording means that are arranged laterally beside the conveyor belt and are directed towards the tablet-like products from the side, it is likewise conceivable, and economically achievable, for appropriately oriented mirror elements to be arranged laterally beside the tablet-like products, which mirror elements allow for an optical recording means arranged above the conveyor belt to record the tablet-like products from a lateral viewing angle. It is thus possible for the tablet-like products to be optically captured not only in the peripheral direction of the tablet-like products, but also from the sides or from the respective end caps. In particular in the case of an embodiment of this kind, the optical capture means can also be operated as an optical inspection device, by means of which the quality of the tablet-like products 6 is optically captured, monitored and evaluated from a plurality of sides.

It is preferably possible for the at least one optical recording means to comprise at least one row-like or matrix-like imaging sensor. Suitable imaging sensors may for example be commercially available or individually adjusted CCD sensors or CMOS sensors. It is likewise possible, and may be advantageous, to use, more developed sensors, such as active pixel sensors or photodiode arrays as imaging sensors. The evaluation of the image information of a row-like imaging, sensor is possible using of complex apparatus, even at high speeds of the conveyor belt. A matrix-like imaging sensor makes it possible for a plurality of rows of tablet-like products to be captured simultaneously, and to be optically checked for example by means of comparing a plurality of temporally successive recordings. Evaluation of sensor values of an imaging sensor provided in digital form is possible cost-effectively, using commercially available components and in a simple manner. A single optical recording means may comprise, a plurality of row-like or matrix-like imaging sensors, the sensor information of which is combined and recorded together. It is likewise possible to arrange a plurality of optical recording means, comprising just one row-like or matrix-like imaging sensor in each case, along the conveyor belt, in order to allow for mutually independent optical capture of the tablet-like products conveyed on the conveyor belt and to thus possibly improve the accuracy of the optical capture.

According to a particularly advantageous embodiment of the inventive concept, the conveyor unit comprises a roller belt having rotatably mounted rollers that are oriented transversely to the conveying direction and are arranged so as to be spaced apart in the conveying direction, wherein a spacing between two adjacent rollers is less than a smallest diameter of the tablet-like products to be conveyed. A roller belt of this kind makes it possible to promote, in a simple manner, a row-like arrangement of a plurality of tablet-like products side-by-side between two adjacent rollers of the roller belt. In this case, it is optionally particularly advantageous for the rollers to be driven in a direction of rotation, during a conveying movement of the conveyor belt, such that a rotational movement of the rollers causes the tablet-like products arranged thereon to perform a rotational movement in the opposite direction. In this way, it is possible for the individual tablet-like products to be rotated about an axis of rotation, during a conveying movement of the conveyor belt, such that the tablet-like products can be recorded and checked from all sides, by means of an optical checking device arranged in a stationary manner above the conveyor belt. In addition, the rotational movement of the rollers promotes the row-like arrangement of the tablet-like products between two adjacent rollers, such that the feeding of an individual layer of tablet-like products, on the upper face of the conveyor belt formed by the roller belt, is assisted, in the region of the feeding device, in, a manner requiring relatively little structural complexity.

Particularly advantageously, it is optionally possible for the optical recording means to be configured and arranged such that the tablet-like products that are moved on the conveyor belt, in the conveying direction, and are caused to perform a rotational movement, are optically recorded for a sufficiently long recording time in order for it to be possible to make an optical recording of the tablet-like products that extends over the entire periphery. For this purpose, the optical recording means may have a sufficiently large viewing angle. A recording means, for example a camera, that is arranged above the conveyor belt., in a stationary manner, then captures a portion of the conveyor belt in the conveying direction. Said portion should expediently be sufficiently large that each tablet-like product that is conveyed on the conveyor belt, through said portion, in the conveying direction, rotates completely about the axis of rotation at least once, within the portion, and as a result every surface region of the tablet-like product, in the peripheral direction, is captured by the recording means. It is likewise possible for a recording means comprising a row-like sensor to be pivotably arranged above the conveyor belt, and to travel with the tablet-like products, conveyed past in each case, for a sufficiently long recording time that each tablet-like product is captured by the row-like sensor at least over one complete rotational movement, and as a result every surface region can be monitored, in the peripheral direction.

In combination with laterally arranged mirror elements, the surface regions of the tablet-like products oriented transversely to the optical recording means can also be captured by the optical recording means, such that complete monitoring of the visible surface of the tablet-like products is made possible.

According to the invention it is optionally possible for the automated conveying device to comprise a counter, by means of which the tablet-like products conveyed on the conveyor belt can be counted. The counter, may be an integrated component of the optical capture means. It is likewise possible for the counter to be formed for example by sensors that mechanically sense the tablet-like products on the conveyor belt, or by a separate light barrier that shines through between two adjacent rollers of the conveyor belt, and in the process can capture and evaluate a deactivation brought about by the tablet-like products conveyed through the light barrier. A mechanical counter is also conceivable, by means of which for example pivotably mounted measuring tongues protrude onto the upper face of the conveyor belt from above, and are, deflected and pivoted by a tablet-like product conveyed on the conveyor belt, which can be captured and evaluated by a suitable measuring device.

Expediently, it is optionally possible for a separation device to be arranged behind the optical capture means, in the conveying direction, by means of which separation device individual tablet-like products can be separated from the conveyor belt. It is thus possible for the optical capture means to be used to check the individual tablet-like products with respect to specified quality criteria and to actuate the separation device such that those tablet-like products that do not meet the specified quality criteria are separated and removed from the conveyor belt in an automated manner. A separation device of this kind makes it possible for a completely automated check of the tablet-like products conveyed on the conveying device to be performed, without a checker having to participate or'intervene with manual actions.

In view of a high conveying capacity, it is possible, according to an optional embodiment of the inventive concept, for the separation device to comprise an associated separation element for each track of tablet-like products formed on the conveyor belt. The separation element can for example comprise a suction device having a suction opening that is arranged directly above the tablet-like products that are conveyed in a track-like manner along the conveyor belt. In the case of a tablet-like product that is identified as faulty in the optical capture means, the relevant tablet-like product is suctioned from the upper face of the conveyor belt by the associated suction device and supplied to a container for faulty products that is arranged beside the conveyor belt. The suction device can also be arranged along a positioning means that is displaceable transversely to the conveying direction, such that the entire conveying width of the conveyor belt can be covered by one single suction opening, and faulty products can be suctioned and removed from a row of the conveyor belt being carried past, irrespective of the track to which said products belong.

According to an advantageous embodiment of the inventive concept, the filling device comprises a suitable portioning means for each of the tracks of tablet-like products conveyed on the conveyor belt. The portioning means can comprise a suitable flap or switch mechanism for each of the tracks, in order for it to be possible to fill the tablet-like products that are conveyed in one track and have been counted by the optical capture means or by a separate counter, into a filling container assigned to the relevant track, in a specifiable quantity. It is also possible for the portioning means to comprise a weight recording device for each filling container, such that the portioning means can be controlled or regulated by the weight recording device in order to fill a specifiable weight of the tablet-like products into the relevant filling container. The flaps or switches can be actuated and controlled in an automated or manual manner, by means of a suitable actuation mechanism. The portioning means can also comprise a separate optical capture means, in order to count or perform an optical check of the tablet-like products immediately before performing filling of the individual tablet-like products.

### BRIEF DESCRIPTION OF THE DRAWINGS

Embodiments for a configuration according to the invention of an automated conveying device will be described in greater detail in the following, which embodiments as shown by way of example in the drawings. In the drawings:

FIG. 1 is a schematic view of an embodiment according to the invention of an automated conveying device,

FIG. 2 is a schematic view of an automated conveying device, likewise according to the invention, of a different configuration,

FIG. 3 is an enlarged detailed view of a detail of the conveyor belt of the automated conveying device, which conveyor belt is formed as a roller belt,wherein a plurality of tablet-like products are arranged on the roller belt,

FIG. 4 is a perspective view of a detail of the conveyor belt, wherein individual rows are formed by the rollers of the roller belt, which are arranged so as to be spaced apart, in each of which rows three tablet-like products are arranged side-by-side and form three tracks of tablet-like products, directed in the conveying direction, on the conveyor belt,

FIG. 5 is a schematic side view of a feeding, device for feeding individual tablet-like products onto the conveyor belt,

FIG. 6 is a schematic cross section through an interior of the feeding device comprising a track-forming separation device,

FIG. 7 is a cross section through the conveyor belt in the region of a separation device, and

FIG. 8 is a schematic cross section through an interior of the feeding device comprising a track-forming separation device that consists of or comprises a plurality of guide elements arranged directly over the conveyor belt, and that is configured in a manner deviating from the track-forming separation device shown in FIG. 6.

### DETAILED DESCRIPTION

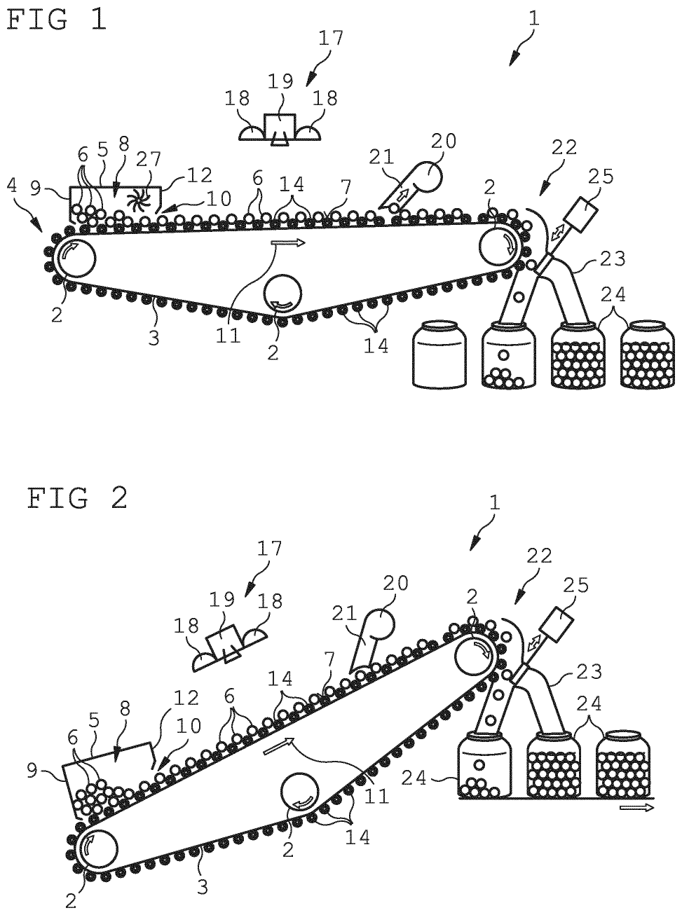

An automated conveying device 1, shown schematically in a side view in FIGS. 1 and 2, comprises a conveyor belt 3 that revolves continuously around three deflection rollers 2. A feeding device 5 for feeding tablet-like products 6 onto an upper face 7 of the conveyor belt 3 is arranged at a first end 4 of the conveyor belt 3. In this case, a large number of tablet-like products 6 are located in an interior 8 of the feeding device 5, which products, owing to the side walls 9 that surround the interior 8 on three sides, can be fed onto the conveyor belt 3 and conveyed further only through a slotted recess 10, wherein the slotted recess 10 is formed in a side wall 12 of the feeding device 5 that faces in a conveying direction 11 of the conveyor belt 3.

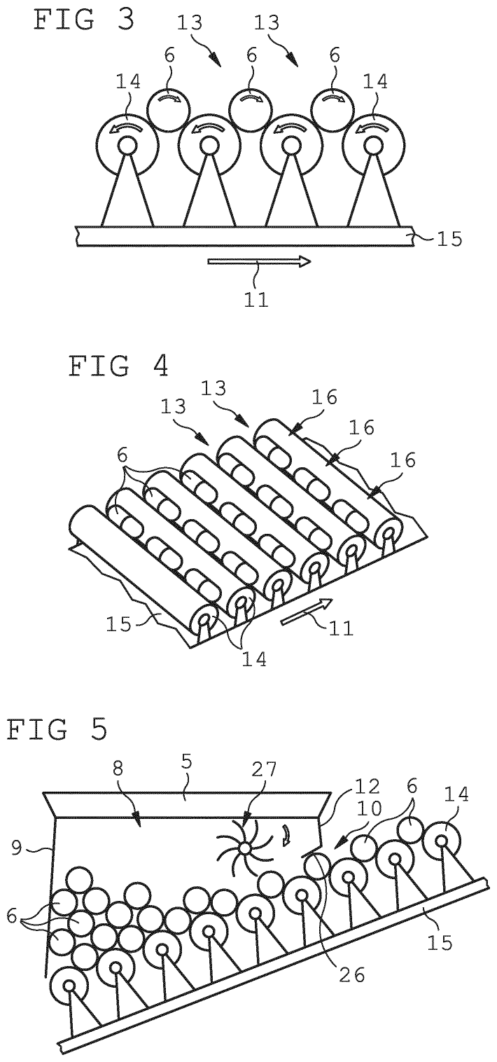

The conveyor belt 3 is a row-forming conveyor belt 3, and therefore a plurality of tablet-like products 6 are arranged side-by-side, transversely to the conveying direction 11, in a row 13 specified by the conveyor belt 3. The individual rows 13 are also formed by rollers 14 arranged transversely to the conveying direction 11, which rows can have a mutual spacing in the conveying direction 11 that is less than a smallest diameter of the tablet-like products 6. The rollers 14 arranged on a flexible conveyor belt 15 are rotatably mounted and can be caused to rotate by means of a suitable drive mechanism. Rotation of adjacent rollers 14 of the conveyor belt 3 in the same direction also causes the tablet-like products 6 that are arranged thereon in a row-like manner to perform a rotational movement in the opposite direction (FIG. 3). In the embodiment shown in FIG. 4, the rows 13 of the tablet-like products 6 arranged between two adjacent rollers 14 comprise three tablet-like products 6 that are arranged side-by-side and that accordingly form three tracks 16 of successive tablet-like products 6 in the conveying direction 11.

The tablet-like products 6 that are arranged on the conveyor belt 3 in a row-like and track-like, and thus matrix-like, manner are conveyed past, under an optical capture means 17, by the conveyor belt 3. In the embodiment shown by way of example, the optical capture means 17 comprises two illumination devices 18 and a row-like CMOS camera 19. Both the illumination devices 18 and the CMOS camera 19 extend over a conveying width of the conveyor belt 3 and are oriented transversely to the conveying direction 11. The optical capture means 17 can count the tablet-like products 6 conveyed past said capture means on the conveyor belt 3. Furthermore, appropriate evaluation of the imaging information recorded by the CMOS camera 19 makes it possible to perform an optical check and to monitor whether the individual tablet-like products 6 meet specified criteria, for example with respect to the shaping thereof and the coloring thereof. The rotational movement of the rollers 14 also causes the tablet-like products 6 to rotate, such that the CMOS camera 19 can record and monitor the tablet-like products from all sides.

A separation device 20 is arranged after the optical capture means 17, in the conveying direction 11. The separation device 20 shown by way of example in FIG. 7 comprises a separate suction device 21 for each track 16, which suction device can suction and remove from the conveyor belt 3, in accordance with the quality check performed by the optical capture means 17, the individual tablet-like products 6 which are conveyed past, under the separation device 20, by the conveyor belt 3. The separation device 20 is shown by way of example in FIG. 7.

Following the separation device 20 a filling device 23 is arranged at a second end 22 of the conveyor belt 3, by means of which filling device a filling container 24, provided there, can be filled with a specified number of tablet-like products 6. The filling device 23 comprises a portioning means (not shown in greater detail), by means of which the filling container 24 associated in each case can be filled with a specified quantity of to products 6. In this case, each individual track 16 is assigned a flap or distribution mechanism. By means of a pivoting flap that can be actuated and pivoted by a controller of the portioning means, or by means of a closure slide 25, for example, it is possible to switch from filling a filling container 24 that is currently full, to filling a filling container 24 that is to be filled next, such that, in the case of a continuously revolving conveyor belt 3, each individual filling container 24 can be filled with the specified number of quantity of tablet-like products (L It is also possible for the flap or distribution mechanisms of a plurality of tracks 16 to be combined in order to fill one filling container 24, respectively, and for the tablet-like products 6 of a plurality of tracks 16 to be combined.

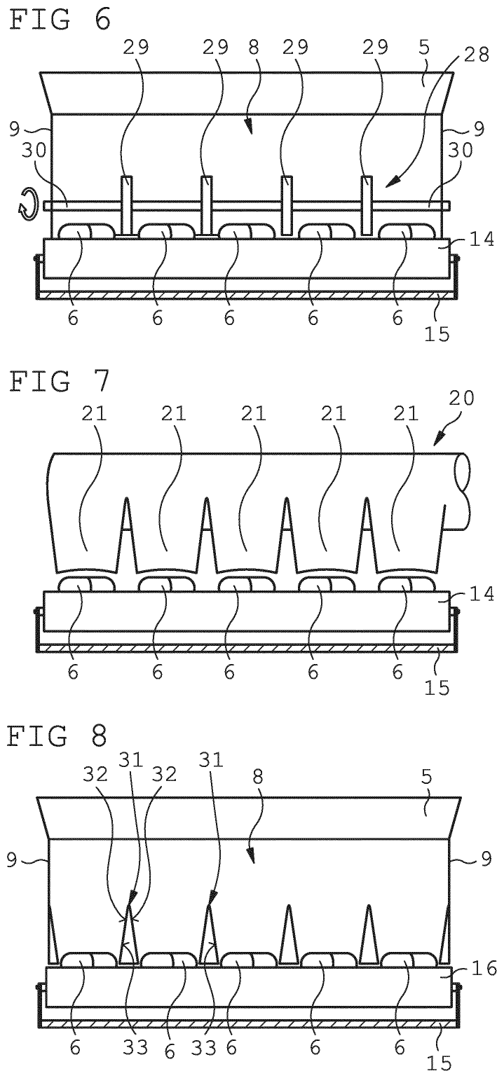

FIGS. 5 and 6 show various embodiments of the feeding device 5, by way of example. A screen 26 that is arranged in the side wall 12, directly above the slotted recess 10, and is angled towards the inside, forms a layer separation means which achieves the effect whereby only a layer of tablet-like products 6, arranged in the rows 13 and in the tracks 16, that is resting directly on the upper face 7 of the conveyor belt 3 can leave the interior 8 of the feeding device 5, on the conveyor belt 3. All products 6 arranged on top of one another, above said first layer, are retained by the screen 26, in this case, the screen 26 is arranged in a height-adjustable manner, above the slotted recess 10, on the side wall 12 of the feeding device 5, in order to allow for simple adjustment to tablet-like products 6 of different sizes. The row-like arrangement of a plurality of tablet-like products 6 side-by-side on the conveyor belt 3 can be specified and promoted by a suitable configuration of the conveyor belt 3. As a result, the conveyor belt 3 can, as shown by way of example in FIG. 3 to 7, consist of or comprise,a roller belt comprising a plurality of rollers 14 that are arranged side-by-side and that are rotatably mounted on a flexible conveyor belt 15. In addition, a rotatably mounted brush roller 27 can optionally be arranged and driven in the interior 8 of the feeding device 5 such that only the layer of tablet-like products 6 that rests directly on the conveyor belt 3, in the individual rows 13, can emerge from the feeding device 5 unimpeded and be conveyed by the conveyor belt 3, while tablet-like products 6 located thereabove are removed by the brush roller 27 and retained;in the interior 8 of the feeding container 5.

The track-like arrangement of the tablet-like products 6 arranged side-by-side in a row 13 can be specified by means of a suitable, track-forming separation device 28. In the embodiment shown by way of example in FIG. 6, the separation device 28 is formed of a plurality of circular discs 29 that are rotatably mounted on a shaft 30 and divide the interior 8 of the feeding device 5, which is delimited by the external side walls 9, into five tracks 16. A rotational movement of the circular discs 29 arranged on the shaft 30 specifies and promotes the track-like arrangement of the tablet-like products 6 on, the conveyor belt 3. Instead of the rotating circular discs 29, it is also possible for guide plates or partition elements to be arranged in a stationary manner in the interior 8, in the feeding device 5, which plates or elements protrude directly as far as the upper face 7 of the conveyor belt 3 and divide the tablet-like products 6, which are initially arranged in a disordered manner in the interior 8 of the feeding device 5, into individual tracks 16 and position said products accordingly on the conveyor belt 3. FIG. 8 shows, by way of example, a separation device 28 in the interior 8 of the feeding device 5, which separation device is configured in a manner deviating from that in FIG. 6. The track formation of the individual tracks 16 of tablet-like products 6 is achieved by prism-shaped guide elements 31 having a triangular cross sectional area, which guide elements extend in the conveying direction 11. In each case just one individual tablet-like product 6 can rest on the conveyor belt 3 and be conveyed by the conveyor belt 3, between two adjacent guide elements 31 arranged transversely to the conveying direction 11.

Guide elements 31 of this kind can also be arranged along the conveyor path of the conveyor belt 3 so as to be spaced apart from the feeding device 5, in order to bring about another check and, if necessary, orientation of the individual tracks 16 of tablet-like products 6 on the conveyor belt 3. The upper faces 32 of the guide elements 31 facing the tablet-like products 6 may be mirrored, such that a reflection of end caps 33 of the tablet-like products 6 oriented transversely to the conveying direction 11 can be projected upwards and recorded by an optical recording means 19 arranged thereabove, in order for it to be possible to also check and monitor the laterally arranged end caps 33 of the table-like products 6.

1. Automated conveying device for tablet-like products, comprising
a row-harming conveyor belt on which the tablet-like products are stored in mutually separated rows transversely to a conveying direction of the conveyor belt and are transported in the conveying direction,
a feeding device, arranged at a first end of the conveyor belt, for feeding the tablet-like products onto the conveyor belt,
an optical capture means for automated capture of individual tablet-like products on the conveyor belt, and
a filling device arranged at a second end of the conveyor belt that is opposite the first end, by cans of which the tablet-like products can be transferred from the conveyor belt into a filling container.

2. Automated conveying device according to claim 1, the feeding device comprises a feeding opening that adjoins an upper face of the conveyor belt and extends transversely to the conveying direction of the conveyor belt and through which the tablet-like products can be fed onto the upper face of the conveyor belt.

3. Automated conveying device according to claim 2, the feeding device comprises a track-forming separation device by means of which the tablet-like products are fed side-by-side, in a plurality of tracks, onto the upper face of the conveyor belt.

4. Automated conveying device, according to claim 3, the track-forming separation device comprises a plurality of separation elements that are arranged transversely to the conveying direction of the conveyor belt and are oriented in the conveying direction.

5. Automated conveying device according to claim 1, the feeding device comprises a layer separation means in the region of the feeding opening, which prevents feeding of tablet-like products arranged on top of one another, onto the conveyor belt, through the feeding opening.

6. Automated conveying device according to claim 1, the conveyor belt has an orientation that rises upwards in the conveying direction, at least in the region of the feeding opening of the feeding device.

7. Automated conveying device according to claim 1, the optical capture means comprises at least one optical recording means that is arranged transversely to the conveying direction of the conveyor belt and extends over a conveying width of the conveyor belt.

8. Automated conveying device according to claim 7, the optical capture means comprises at least one further optical recording means or a mirror device arranged laterally beside the conveyor belt, which allows for optical capture, of the tablet-like products, conveyed on the conveyor belt, from a lateral viewing angle.

9. Automated conveying device according to claim 7, the at least one optical recording means comprises at least one row-like or matrix-like imaging sensor (19).

10. Automated conveying device according to claim 1, the conveyor belt comprises a roller belt having rotatably mounted rollers that are oriented transversely to the conveying direction and are arranged so as to be spaced apart in the conveying direction, wherein a spacing between two adjacent rollers is less than a smallest diameter of the tablet-like products to be conveyed.

11. Automated conveying device according to claim 10, the rollers can be driven in a direction of rotation, during a conveying movement of the conveyor belt, such that a rotational movement of the rollers causes the tablet-like products arranged thereon to perform a rotational movement in the opposite direction.

12. Automated conveying device according to claim 11, the optical recording means is configured and arranged such that the tablet-like products that are moved on the conveyor belt, in the conveying direction, and are caused to perform a rotational movement, are optically recorded for a sufficiently long recording time in order for it to be possible to make an optical recording of the tablet-like products that extends over the entire periphery.

13. Automated conveying device according to claim 1, the automated conveying device comprises a counter, by means of which the tablet-like products conveyed on the conveyor belt are counted.

14. Automated conveying device according to claim 1, a separation device is arranged after the optical capture means, in the conveying direction, by means of which separation device individual tablet-like products can be, separated from the conveyor belt, wherein the separation device may comprise an associated separation element for each track of tablet-like products formed on the conveyor belt.

15. Automated conveying device according to claim 1, the filling device comprises a suitable portioning means for each of the tracks of tablet-like products conveyed on the conveyor belt.
